(19) United States
(12) Patent Application Publication
(10) Pub. No.: US 2010/0009744 A1
(43) Pub. Date: Jan. 14, 2010

(54) Method and System for a Casino Game Providing a Repetitive Event Wager

(75) Inventors: Frank Mugnolo, Broadview, IL (US); Anthony Mugnolo, Broadview, IL (US); Leonardo Mancari, Lemont, IL (US); Robert DeAngeles, Downers Grove, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Casino Gaming, L.L.C., Bellwood, IL (US)

(21) Appl. No.: 12/171,537

(22) Filed: Jul. 11, 2008

(51) Int. Cl. G06F 17/00; A63F 3/08

(52) U.S. Cl. 463/27; 273/274

(57) ABSTRACT

In a casino game, such as Roulette, players are offered the ability to place a repetitive event wager that the same event will occur consecutively a particular number of times in a row. In the example of Roulette, before the roulette wheel is spun, a player places a repetitive event wager. The roulette wheel is then spun, and the ball lands on a particular pocket. If the event did not occur as a result of the spin, the repetitive event wager is over, and the player loses the wager. If the event did occur, the process is repeated. Ultimately, if the event occurs the particular number of times in a row, the player is paid a payout of a predetermined multiple of the amount of the repetitive event wager.

### BACKGROUND OF THE INVENTION

1. Field of the invention

The invention is directed to a casino game. In particular, the invention is directed to wagering games of chance, such as “roulette.” More particularly, the invention is an improved method applicable to casino wagering games such as roulette and directed to a novel type of wager.

2. Description of the Prior Art

Standard Roulette is most often played at a casino or like venue. The game involves a spinning wheel and a ball and a number of players, who wager on the outcome of where the ball will land on the spinning wheel.

The details of game play and the rules in conventional Roulette are well known. However, to appreciate how the invention is applied to Roulette, it would be useful to summarize game play and some of the standard rules to provide a frame for describing the invention. For this purpose, the description of the roulette game in the next five paragraphs is generally taken from U.S. Pat. No. 6,467,770.

Historically, the game of Roulette has succeeded in attracting the attention of casino gamblers worldwide, and includes a Roulette wheel having a plurality of numbered pockets (38 pockets in “American Roulette,” 37 pockets in “European Roulette”) around a periphery inside a bowl-shaped housing. Each pocket is associated with a color as well, such as red or black in conventional Roulette, that creates a background for each number of the numbered pockets. Also, there may be a “0” and possibly a “00” pocket on the Roulette wheel and these pockets are typically associated with yet another color, such as green.

The housing is adapted to spin or rotate about a vertical axis, and an operator, or croupier, introduces a ball into the spinning Roulette wheel housing tangentially to the periphery of the wheel and in a direction opposite to the rotation of the wheel. Typically, the ball travels around the periphery of the housing multiple times before falling toward the center of the wheel. Ultimately, the ball comes to rest in one of the pockets in the Roulette wheel. Typically, a number of obstacles on the outer periphery prevents a simple, harmonious fall of the ball and assures the character of Roulette as a game of chance.

Gamblers place bets on where the ball will ultimately come to rest for each round of the game by placing chips or markers on a bet layout on the surface of the Roulette table. The markers or chips are placed in a position corresponding to the wager made on the outcome of the round. For example, a player may bet on a single pocket number by placing a chip on a corresponding place on a layout configured to organize Roulette bets. If the player wins the bet, he wins a payout depending on the odds of winning the bet, which is, for example, typically 35:1 for a “straight up” bet on a particular numbered pocket of the wheel.

Other number combination bets that may be made include a “split” that the ball will fall into one of two numbered pockets with 17:1 odds, a “corner” bet that the ball will fall into one of four numbered pockets with 8:1 odds, a “street” bet that the ball will fall into one of three numbered pockets with 11:1 odds, and a “six line” bet that the ball will fall into one of six numbered pockets with 5:1 odds.

A variety of other bets with smaller payouts may be made as well, including whether the ball will land in a “odd” or “even” pocket, a “small” pocket (one of pockets 1-18), a “big” pocket (one of pockets 19-36), a black pocket or red pocket for which the payout is 1:1, and a “dozen” bet and a “column” bet for which the payout is 2:1. If the ball lands in the pocket numbered “0” (or “00” in American Roulette), in one version of the game the house wins every bet, i.e., every bet loses, except bets wagered on the “0” pocket (or “00” in American Roulette). In another version of the game popular in Europe, all bets except 1:1 payout bets and bets wagered on the “0” pocket (or “00” in American Roulette) lose, and 1:1 payout bets lose half of their value when the ball lands in the pocket numbered “0” (or “00” in American Roulette).

Other casino wagering games, such as BlackJack, Craps, Baccarat, poker, video poker, and slots, are also well known in the art. While the rules of each game differ, they all involve a player making some type of wager that a particular event will occur.

A variation to the game of Roulette using progressive jackpots is described in U.S. Pat. No. 6,059,659, entitled “Roulette Table Having Progressive Jackpots.” This patent discloses a roulette game with a conventional betting layout and a progressive jackpot layout. Players may make wagers on the progressive jackpot game wherein the jackpot is accumulated from losing wagers on the progressive jackpot layout. The progressive jackpot is won by a wagered winning number being selected by the roulette wheel in a predetermined number of successive spins. The '659 patent discloses the use of regular value chips on the conventional betting layout and “non-value” chips on the progressive jackpot betting layout. Another variation to the game of Roulette using progressive jackpots is described in U.S. Pat. No. 5,743,798, entitled “Apparatus for Playing a Roulette Game Including a Progressive Jackpot.” This patent discloses a roulette game including a plurality of coin acceptors to enable players to place an optional progressive jackpot wager. Players win the progressive jackpot by betting on the same winning number four times in a row.

Casinos make money by offering games such as Roulette because the rules result in the casino receiving a slight advantage over the players. With a large volume of bets over time, the casino will reap large rewards. In light of this, it is advantageous to casinos to offer bets which attract players and which provide the casino with an edge—even if it is a very slight edge. It may even be attractive to offer a bet for which there is no edge to attract other bets that do provide an edge to the casino. Players, on the other hand, typically play the game for shorter periods of time than the house or casino (which is in theory always open). Accordingly, players may focus less on the statistically averages and more on “gut” feeling when making playing decisions. It is therefore desirable to offer bets and options that maintain or enhance the casino's edge in a game while also providing more flexibility to the player and attracting more play.

### BRIEF DESCRIPTION OF THE DRAWINGS

FIG. 1 is a plan view of a covering of the top of a Roulette table which can be used with a preferred embodiment

FIGS. 2-4 show a betting area which can be used with a preferred embodiment.

FIGS. 5-6 show an alternative betting area which can be used with a preferred embodiment.

FIG. 7 is a flow chart illustrating the steps of a preferred embodiment of the present invention.

FIG. 8 is an example architecture of an embodiment in which a game including the present invention is implemented electronically.

### DETAILED DESCRIPTION OF THE PRESENTLY PREFERRED EMBODIMENTS

The preferred embodiment(s) of the present invention is a modification to the traditional game of Roulette that enhances the experience of the player and contributes to the profitability of the house or casino. The term “house” is used herein to mean whatever entity the player is playing against, such as the casino. The modification can be accomplished without significant impact on the speed of the game and without the use of a cumbersome progressive jackpot scheme. The following description is presented to enable a person of ordinary skill in the art to make and use the invention and is provided in the context of a particular application and its requirements. Various modifications to the preferred embodiment will be readily apparent to those skilled in the art, and the generic principles defined herein may be applied to other embodiments and applications without departing from the spirit and scope of the invention. Thus, the present invention is not intended to be limited to the embodiments shown but is to be accorded the widest scope consistent with the principles and features disclosed herein. For example, the present invention may be applied to casino wagering games other than Roulette.

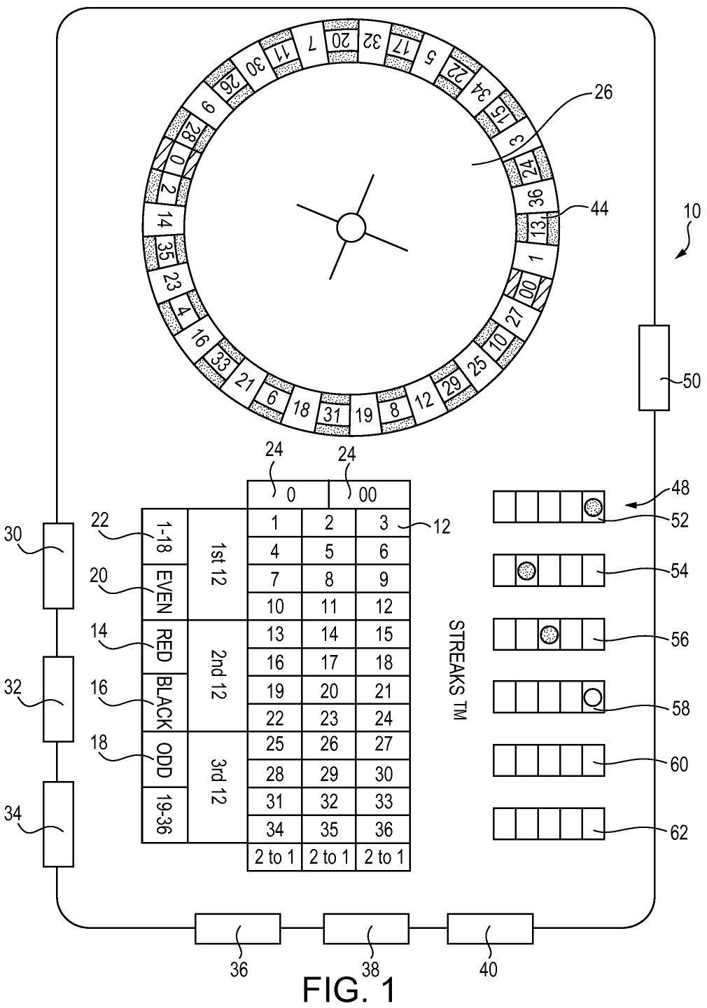

To help illustrate a preferred embodiment, this description will refer to FIG. 1 which shows the image of an example game play area 10 or table of a Roulette game table for a game of Roulette according to one embodiment of the invention. The game play area 10 includes the conventional wagering areas such as individual numbers (e.g. “3” 12); red 14; black 16; odd 18; even 20; “0” and “00” 24; and possibly other areas that indicate a bet on multiple numbers (e.g. “1-18” 22). Such numbers and other betting areas are typically printed on a felt that covers the top of the Roulette table. Also, the game play area includes the spinning wheel and structure described above 26. The wheel includes the numbered colored pockets described above, e.g. 44 (“13”, colored black). Each number is associated with a color. For example, the following table lists the colors associated with each number in a typical American Roulette wheel and table:

| Numbers | Corresponding Color |
|---|---|
| 1, 3, 5, 7, 9, 12, 14, 16, | Red |
| 18, 19, 21, 23, 25, 27, 30, 32, 34, 36 | |
| 2, 4, 6, 8, 10, 11, 13, 15, | Black |
| 17, 20, 22, 24, 26, 28, 29, 31, 33, 35 | |
| 0, 00 | Green |

The are a number of positions around the betting table 30, 32, 34, 36, 38, 40 where players can sit or stand and place bets on the table using chips, markers and/or cash. Although FIG. 1 shows six player positions, the invention is not so limited. Indeed, there may be seven, or any other number, of such player positions. The dealer/croupier typically stands at a position near the wheel 26, such as position 50. The invention is not limited to any particular configuration of a gaming table.

In one embodiment of the invention, a repetitive wagering area 48 is provided on the game play area 10. Individual repetitive wagering areas 52, 54, 56, 58, 60, 62 may be provided for each potential player. So, for example, repetitive wagering area 52 may correspond to player position 30, repetitive wagering area 54 corresponds to player position 32, repetitive wagering area 56 corresponds to player position 34, repetitive wagering area 58 corresponds to player position 36, repetitive wagering area 60 corresponds to player position 38, and repetitive wagering area 62 corresponds to player position 40. The repetitive wager areas 48 may be anywhere on the game play area 10. In a preferred embodiment these wager areas are located near the dealer position so that the dealer can keep track of and manipulate the markers and/or chips used in the repetitive wager area.

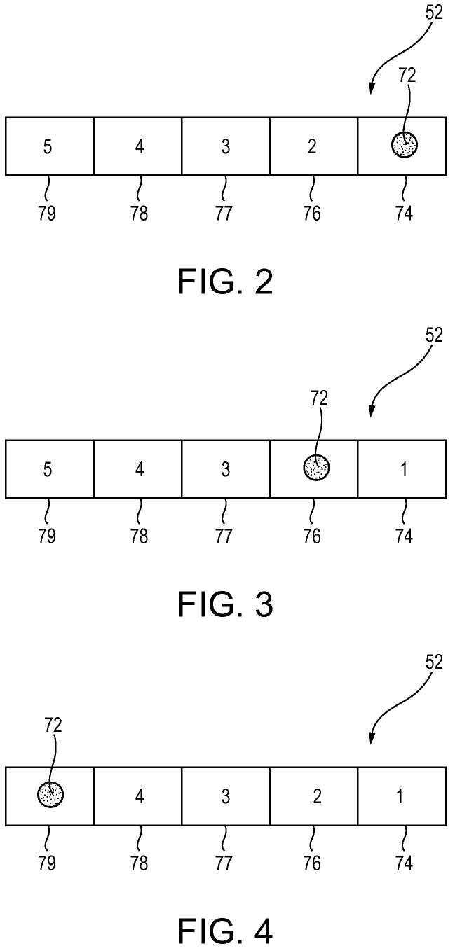

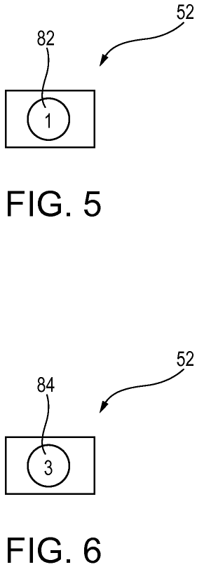

Furthermore, the repetitive wagering areas 48 may be any suitable shape or area, circular, rectangular, triangular, star-shaped, and so on, and may include any suitable designation, icon, or indication to identify that the area is for use in the repetitive wager. For example, referring to FIGS. 2-4, the repetitive wager area 52 illustrated in FIG. 1 is illustrated in more detail. As another example, FIGS. 5-6 illustrate another way of configuring the repetitive betting area. FIGS. 2-6 are described in more detail below. The invention is not limited to any particular configuration of a repetitive wagering area or, for that matter, to the use of any repetitive wagering area.

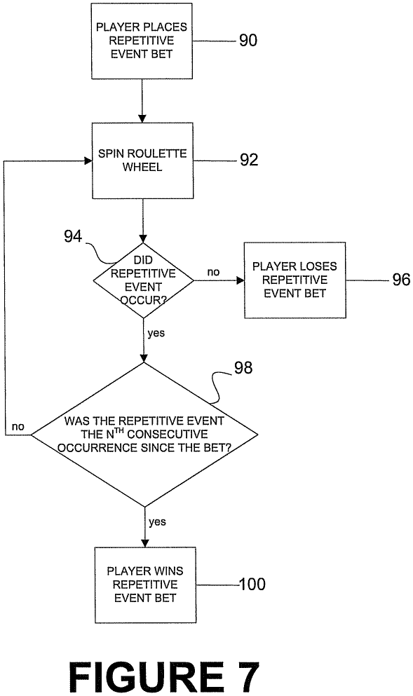

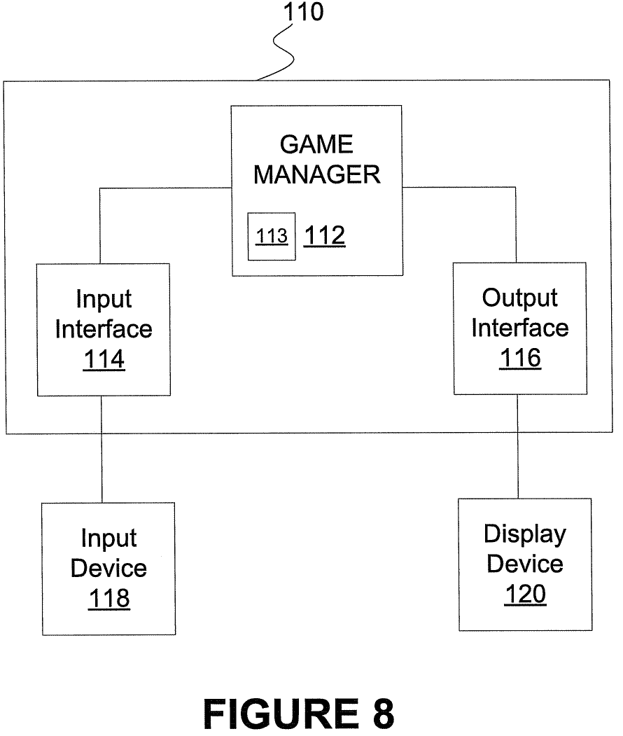

A preferred embodiment of the invention is illustrated in FIG. 7. The flow chart shown in FIG. 7 provides only an example of one embodiment and it should be understood that more or fewer steps may be utilized or the steps may occur in one or more orders that are different from the order of steps shown in FIG. 7 without departing from the spirit of the invention. As shown at block 90, first a player places a repetitive event bet or wager. In a preferred embodiment, the repetitive event eligible for such a wager may be that the ball will land on either a red or black pocket after a spin of the roulette wheel. Once the bets are placed, the roulette wheel is spun as shown at block 92. The roulette wheel may be a physical wheel as shown in FIG. 1 or may be a virtual wheel in the case of a video or computer version, as described below with respect to FIG. 8. Next, it is determined if the repetitive event occurred (e.g., if the spin resulted in the ball landing on red), as shown at block 94. If the repetitive event wagered on did not occur, the player loses the repetitive event bet as shown at block 96. If the repetitive event wagered on did occur, next it is determined whether the repetitive event was the Nth consecutive occurrence of the repetitive event since the bet was placed, as shown at block 98. In a preferred embodiment, the repetitive event bet or wager is that the repetitive even will occur 5 consecutive times. In other words, that there will be a “streak” of 5 consecutive repetitive events. The invention is not limited to a particular number.

If the repetitive event was not the Nth consecutive occurrence of the repetitive event since the bet was placed, the repetitive event bet continues and the process starting at block 92 is repeated. If the repetitive event was the Nth consecutive occurrence of the repetitive event since the bet was placed, the player wins the repetitive event bet as shown at block 100. In a preferred embodiment, when this occurs the dealer provides the winning amount of the wager to the player. In a preferred embodiment, the winning amount is a predetermined multiple of the amount of the repetitive event wager. The invention is not limited, however, to any particular approach or technique for how the winning wager is paid out.

The flow chart of FIG. 7 shows how a preferred embodiment of the invention would work with respect to one player making one repetitive event bet. The same process could be followed for multiple repetitive event bets and for multiple players. The preferred embodiment also permits players to make repeated repetitive event wagers after consecutive spins of the roulette wheel, so that it is possible that there may be multiple repetitive event wagers that are overlapping from the same player or from multiple players. The flow chart of FIG. 7 also shows a preferred embodiment in which the invention is applied to the casino game of Roulette. In this embodiment, all other rules of the game of Roulette are unaffected by the invention. The invention may also be applied to bets in other casino games, i.e., BlackJack, Craps, or Baccarat.

The invention is not limited to any particular repetitive event, but rather wagering that a predefined repetitive event will occur for a predetermined number of occurrences. In Roulette, for example, the invention may be applied to allow a player to bet that there will be a predetermined number of red numbers in a row, a certain number of green numbers in a row, a certain number of odd (or even) numbers in a row, or any other typical Roulette bets in a row (e.g. 1-18, 19-36, 1^{st} 12, 2^{nd} 12, 3^{rd} 12, rows, columns, clusters of numbers, or even individual numbers). The invention is also not limited to the number of repetitions. Although examples are given herein where there are five occurrences in a row, the invention should not be so limited. The player may be able to bet on any number of occurrences (two or more) and may even be varied from one bet to the next. Alternatively, the number of occurrences may be fixed in certain embodiments.

The preferred embodiment also contemplates providing one payout based on N number of consecutive occurrences of an event. Alternatively, the invention could be applied to permit multiple payouts. For example, in an alternative embodiment a player could place a repetitive event wager that the roulette ball will land on red. The player could be provided a first payout once three consecutive reds have occurred and then a second payout if the “streak” continues. The invention is not limited to any particular number of payouts.

In a preferred embodiment, the payout for a winning repetitive event wager will be slightly less than the actual odds that such a repetitive “streak” of events will occur, to provide the house a slight edge on the bet. Alternatively, the payout can be set to the exact odds of the particular repetitive “streak” of events occurring. The invention is not limited to tying the winning payout to any particular ratio and to whether the payout provides an edge or not to the house or the extent of any edge provided. By way of example only, the payout for a repetitive event bet that there will be 5 blacks or reds in a row on a typical American roulette wheel may be 32:1, which would be the actual odds if the two green pockets did not exist. This is less than the actual odds (approximately 41.9:1) of that repetitive “streak” occurring. The actual odds are calculated by dividing the total number of pockets (38) by the number of pockets that are either red or black (18) and then by calculating the 5^{th} power of that number (multiplying that number against itself 5 times).

Another example payout for a repetitive event bet that there will be 2 blacks or reds in a row on a typical American roulette wheel may be 4:1, which would be the actual odds if the two green pockets did not exist. This is less than the actual odds (approximately 4.46:1) of that repetitive “streak” occurring.

Referring back to FIGS. 1-4, in a preferred embodiment an area, such as area 52, is provided to track repetitive event bets. FIGS. 2-4 show an example layout of such an area 52. For purposes of this example, the repetitive event will need to occur 5 times in a row for a player to win the bet. The repetitive event bet area 52 includes 5 subareas, 74, 76, 77, 78 and 79. When a player wants to place a repetitive event bet, a chip or marker designating the bet is placed in the repetitive event wager area. For example, in one embodiment, assuming a player wants to bet that a black number will come up five times in a row, the player informs the dealer that she wants to make a repetitive bet, e.g. “ten dollars on five blacks in a row”. As shown in FIG. 2, the dealer would then place a black marker 72 on the first position 74 (box 1) of that player's repetitive betting area 52. After the wheel is spun, if the number comes up black, the dealer moves the black marker 72 to the second position 76 (box 2) of the player's repetitive betting area 52 as shown in FIG. 3. After that, the wheel is spun repetitively and, as long as an uninterrupted streak of black numbers comes up, the dealer advances the black marker 72 along one numbered boxes, e.g. to box 3 (third position 77) after the second spin, box 4 (fourth position 78) after the third spin, and box 5 (fifth position 79) after the fourth spin as shown in FIG. 4. So, as long as four successive spins of the Roulette wheel yield black numbers, the black marker 72 is advanced until it rests in fifth position 79 in the repetitive betting area 52. After that, the wheel is spun yet again, and if another black number comes up, the player is paid out the amount of a winning repetitive bet. This layout of a repetitive bet area allows for the players to visually see the progression of their repetitive event bets by providing areas for markers associated with the various stages of a repetitive event beet. In the event that the repetitive event bet is lost (as shown at 96 in FIG. 7) the chip or marker will be preferably removed from the repetitive event wager area by the dealer.

Although FIGS. 2-4 are illustrated using a black chip 72 to indicate a bet on a streak of black numbers, any chip indicating the type of bet could be used, for example the chip could be red to indicate a bet on a streak of red numbers, it could have a letter “O” to indicate a bet on a streak of odd numbers or a letter “E” to indicate a bet on repetitive even numbers. Any type of chip or marker can be used to assist the dealer or players. Alternatively, a plain chip, of the actual chips/money that the player is betting, may be used, and in that case the dealer may have an alternative way of keeping track of what bet the player made. For example, the dealer may write down the bet, store it electronically, or record it or remember it in some other conventional way.

Referring now to FIGS. 5 and 6, an alternative repetitive betting area is shown. This area 52 is a single shape, for example a square or a box. Once the player decides to place a repetitive bet, the dealer places a numbered chip or marker in the area 52 each time the desired result is achieved. For example, in FIG. 5, the player has made some repetitive bet (e.g. that a streak of five red numbers will occur). In FIG. 5, the event bet on has occurred once, thus the dealer places a “1” marker/chip 82 in the betting area indicating that there has been one successful occurrence of the streak or repetitive bet. After a second successful occurrence, the dealer would replace the “1” marker/chip with a “2” marker/chip. As shown in FIG. 3, the dealer would place a “3” marker/chip 84 in area 52 because three successful occurrences have occurred in a row.

The invention is not limited to any particular configuration of a repetitive event wager area and is not even limited to having any such wager area. In the event an embodiment does utilize a repetitive event wager area, the invention is not limited to providing areas for each player. For example, in an alternative embodiment, a single repetitive event wager area is provided for tracking the progress of multiple players' bets. In this alternative embodiment, the croupier could distinguish bets of different players in different manners. For example, different color markers could be used for different players or the markers could be arranged in particular locations in the repetitive event wager area that correspond to different players. In another alternative embodiment, different repetitive event wager areas could be provided for different types of repetitive event wagers. For example, there could be separate areas for bets that the roulette ball will land on black 5 consecutive times and for bets that the roulette ball will land on red 5 consecutive times.

A repetitive or “streak” bet can be placed at any time. Therefore, in a preferred embodiment, the dealer will keep track of each player's repetitive/streak bet(s) by indicating or placing the player's bet in the corresponding space on the table as exemplified above. A single player can have multiple repetitive event wagers pending at the same time even though the wagers were placed at different times. In such a case, multiple markers may appear in the repetitive event wager areas described above at different locations in the repetitive event wager area. Multiple players can have repetitive event wagers pending at the same time betting the same repetitive event will occur N consecutive times. The winning payout is preferably not affected by the number of players who made the repetitive event wager. A streak/repetitive bet can start and stop on any spin of the Roulette wheel. Therefore, once the bet starts, the dealer will keep track of the bet using, for example, the methods described above. Anytime the streak ends before the amount of repetitions that the player wagered on (e.g. the player bet there would be five red numbers in a row and a black number comes up after the fourth spin), the player loses his bet and the dealer takes the bet.

Although FIG. 1 depicts, and the above description focuses on, a typical Roulette table where players sit, the invention is not so limited. For example, the invention can be implemented “virtually” on a computing device, such as a video gaming terminal or on a personal computer where the computer spins a virtual roulette wheel and where the wheel is represented by images displayed on a video terminal. The game can be running on a dedicated computing device located, for example, on the floor of a casino or can be offered on a server which can be accessed by players remotely, such as via the Internet (e.g., Internet-based casinos).

Such an arrangement is illustrated in FIG. 8. As shown in FIG. 8, the modification to a casino game in its various forms described herein can be implemented on a computing device 110. The computing device 110 can be any computing device such as a personal computer, a dedicated video game on the floor of a casino, a handheld computing device, a server or computer connected to the Internet or a network (by any method of connecting two or more computing devices), for example. Such computing devices generally include a central processing unit (CPU) (not shown) such as a microprocessor, a microcontroller, or any device that performs arithmetic, logic, or control operations and a storage device (not shown) such as a magnetic disk, an optical disk or any other volatile (e.g., Random Access Memory (“RAM”)) or non-volatile firmware (e.g., Read Only Memory (“ROM”)) storage system readable by the central processing unit.

The computing device 110 includes a game manager 112. The game manager 112 comprises the logic that manages the casino game. For example, for Roulette, the game manager 112 is programmed to establish the virtual roulette wheel to be spun and actually spins the wheel to select winning numbers. The wheel comprises data stored in the computing device and may be represented by graphics or text displayed to a player. The game manager 112 also manages a game by accepting input from players (such as wagers), by determining winners and losers, and by providing instructions relating to payouts. The game manager 112 preferably interfaces with an input device 118 via an input interface 114. The invention is not limited to any particular type of input device and can include, for example, a keyboard, a mouse, physical buttons on a video gaming device, virtual buttons generated on the display of a video gaming device, or a combination of different input devices. The game manager 112 also preferably interfaces with a display device 120 via an output interface 116. The invention is not limited to any particular type of display device and can include any type of monitor. In an electronic implementation of the invention of the sort depicted in FIG. 8, a repetitive event wager area could be graphically displayed to a player on the display device 120.

The game manager 112 preferably includes a repetitive wager processor or logic 113 that implements the modification (in its various forms) to a casino game described herein. The repetitive wager processor or logic 113 can be a separate module or can be integrated into the game manager 112. The input device 118 and display device 120 an be directly connected to the computing device 110 or can be connected via a network connection (such as the Internet). Also, although the various blocks shown in FIG. 8 are shown separately, various portions of those blocks can be combined or separated into further blocks as known by one of ordinary skill in the art. For example, the game manager 112 can be distributed across multiple computing devices. In addition, the game manager 112 can be implemented in software or hardware.

While the above description focuses on embodiments of the invention implemented in the game of Roulette, the invention is not so limited. A repetitive event wager of the sort described herein can be implemented in any other casino wagering game. By way of example, in the game of BlackJack, it can be implemented to allow a player to make a wager that a particular event (like the dealer or the player being dealt a blackjack, the player winning a hand, the player losing a hand, or the dealer busting) will occur N consecutive times. By way of another example, in the game of Craps, it can be implemented to allow a player to make a wager that a particular event (like the shooter rolling a seven, the shooter rolling a craps, or the shooter rolling a particular number) will occur N consecutive times. By way of another example, in the game of Baccarat, it can be implemented to allow a player to make a wager that a particular event (like the player winning or the bank winning) will occur N consecutive times.

To those skilled in the art to which this invention pertains, the above-described preferred embodiment may be subject to change or modification. Such change or modification can be carried out without departing from the scope of the invention, which is intended to be limited only by the scope of the appended claims.

What is claimed is:

1. A method of playing a casino game, comprising:
offering players the ability to place a repetitive event wager that an event will occur consecutively a particular number of times in a row as a result of an action;
receiving the repetitive event wager from a player, wherein the repetitive event wager has an amount;
taking the action;
if the event did not occur as a result of the action, ending the repetitive event wager; and
if the event did occur as a result of the action, paying to the player a payout for the repetitive event wager if the event has occurred consecutively the particular number of times in a row since the repetitive event wager was received, wherein the payout is a predetermined multiple of the amount.

2. The method of claim 1, wherein the casino game comprises Roulette.

3. The method of claim 2, wherein the action comprises a spin of a roulette wheel and the event comprises a result of the spin.

4. The method of claim 3, wherein the event comprises a roulette ball landing on a particular color.

5. The method of claim 3, wherein the step of offering players the ability to place a repetitive event wager is performed before every spin of the roulette wheel.

6. The method of claim 1, further comprising the step of providing a game table layout with a repetitive event wager area for tracking the progress of the repetitive event wager from the player.

7. The method of claim 6, wherein the repetitive event wager area tracks the progress of a plurality of repetitive event wagers.

8. The method of claim 1, further comprising the step of receiving a second repetitive event wager from the player that a second event will occur consecutively a particular number of times in a row while the previous repetitive event wager is still pending.

9. The method of claim 1, wherein the step of offering players the ability to place a repetitive event wager comprises offering players the ability to make a repetitive event wager that one of a plurality of different events will occur consecutively a particular number of times in a row.

10. The method of claim 1, wherein the amount of the repetitive event wager is determined by the player.

11. The method of claim 1, wherein to receive the payout the player only needs to make the repetitive event wager.

12. A method of playing the casino game of roulette in which a roulette wheel is spun and in which a roulette ball lands on a particular type of pocket on the roulette wheel, comprising:
receiving a repetitive event wager from a player that the roulette ball will land on a predetermined type of pocket as a result of each of a particular number of future consecutive spins of the roulette wheel in a row;
spinning the roulette wheel;
if the roulette ball did not land on the predetermined type of pocket as a result of the spin of the roulette wheel, ending the repetitive event wager; and
if the roulette ball did land on the predetermined type of pocket as a result of the spin of the roulette wheel, paying to the player a payout for the repetitive event wager if the roulette wheel ball has landed on the predetermined type of pocket as the result of each of the particular number of consecutive spins of the roulette wheel in a row since the repetitive event wager was received, wherein the payout is a predetermined multiple of the amount of the repetitive event wager.

13. The method of claim 12, wherein the predetermined type of pocket comprises a pocket colored red.

14. The method of claim 12, wherein the predetermined type of pocket comprises a pocket colored black.

15. The method of claim 12, wherein the amount of the repetitive event wager is determined by the player.

16. The method of claim 12, wherein to receive the payout the player only needs to make the repetitive event wager.

17. The method of claim 12, further comprising the step of providing a roulette game table layout with a repetitive event wager area for tracking the progress of the repetitive event wager from the player.

18. The method of claim 17, wherein the repetitive event wager area tracks the progress of a plurality of repetitive event wagers.

19. The method of claim 12, wherein a repetitive event wager may be placed before every spin of the roulette wheel.

20. A system for providing a repetitive event wager in a casino game wherein the game provides a player the ability to place a wager than an event will occur as a result of an action taken in the casino game, comprising:
a game manager that receives and monitors a wager from the player that the event will occur consecutively a particular number of times in a row and that monitors the result of the action taken; and
an payout processor that provides the player with a payout equal to a predetermined multiple of the amount of the wager if the event occurs consecutively the particular number of times in a row since the wager was received.
